(19) United States
(12) Patent Application Publication
(10) Pub. No.: US 2015/0324511 A1
(43) Pub. Date: Nov. 12, 2015

(54) FLOATING METAL FILL CAPACITANCE CALCULATION

(71) Applicant: Synopsys, Inc., Mountain View, CA (US)

(72) Inventors: Arthur Nieuwoudt, San Francisco, CA (US); Arindam Chatterjee, Saratoga, CA (US); William Patrick Pinello, Scottsdale, AZ (US)

(73) Assignee: Synopsys, Inc., Mountain View, CA (US)

(21) Appl. No.: 14/274,670

(22) Filed: May 9, 2014

(51) Int. Cl. G06F 17/50

(52) U.S. Cl. CPC G06F 17/5081

(57) ABSTRACT

A design layout is obtained that includes floating fill shapes and signal shapes. Capacitance of the signal shapes is calculated. A simple model is used to calculate a first subset of fill shapes which contribute capacitance to the signal shapes. A capacitance model selected to meet an acceptable error level using minimum computational requirements is then selected from a set of capacitance models. The selected capacitance model is then used to extract the capacitance contribution from the first subset of fill shapes. A second subset of fill shapes is then created based on the extracted capacitance values, and if the estimated capacitance contribution is significant, the capacitance of the second subset extracted using the selected capacitance model. Additional iterations are performed for additional signal shapes.

### FIELD OF ART

This application relates generally to semiconductor circuit design, and more particularly to calculating capacitance related to fill shapes.

### BACKGROUND

The design and verification of modern semiconductor circuits is an extremely complex and difficult process involving many different steps. Modern electronic systems are often very large, including tens or even hundreds of millions of transistors, which makes them difficult and expensive to design and validate. The market also drives an ever-increasing demand for performance, advanced feature sets, system versatility, and a variety of other rapidly changing system requirements. System designers are required to make significant tradeoffs in the areas of performance, physical size, architectural complexity, power consumption, heat dissipation, fabrication complexity, and cost, to name a few, in order to achieve design requirements. Each design decision exercises a profound influence on the resulting electronic system. To handle such electronic system complexity, designers create specifications around which to design their electronic systems. The specifications attempt to balance the many and sometimes disparate demands being made of the electronic systems and also implement solutions aimed at controlling exploding design complexity.

Logic system designers develop a system specification to describe the desired behavior of the design. Comparison of proposed designs to the specification helps ensure that the designs meet critical system objectives. This process of comparison is called verification. Logic systems may be described at a variety of levels of abstraction, from low-level transistor layouts to high-level description languages. While verification can take place at any abstraction level, most designers describe and design their electronic systems at a high-level of abstraction using an IEEE Standard hardware description language (HDL) such as Verilog™, SystemVerilog™, or VHDL™. The high-level HDL is useful for several reasons, one being that it is often easier for designers to understand a high-level HDL than lower-level languages, especially for a vast system, and another being high-level HDL's ability to describe highly complex concepts that are difficult to grasp using a lower level of abstraction. Additionally the HDL description can be converted into any of the other levels of abstraction as is helpful to developers. For example, a high-level description can be converted to a logic-level description such as a register-transfer language (RTL), a gate-level (GL) description, a layout-level description, or a mask-level description. Each lower level of abstraction introduces more detail into the design description, culminating in mask-level descriptions, which contain enough information to actually fabricate the integrated circuit.

Additional verification is performed once the different mask layers are defined. Some types of analysis require the information from the mask layers to verify the design. One example of a verification tool that requires mask level information is the final timing analysis, a process that uses capacitance values extracted from the mask level information to provide the most accurate timing information possible. In some cases, timing analysis is performed earlier in the process using estimated capacitance values, but even so, the information from the layout is used to obtain accurate capacitance values.

### SUMMARY

A design layout is obtained that includes floating fill shapes and signal shapes. Capacitance of the signal shapes is calculated and a first subset of the fill shapes is selected that contribute capacitance to the signal shapes. The capacitance contribution of the first subset of fill shapes is estimated using a simple model. A capacitance model is then selected from a set of capacitance models having varying computational requirements and accuracy. The capacitance model is selected to meet an acceptable error level with the minimum amount of computation. The selected capacitance model is then used to extract the capacitance contribution from the subset of fill shapes. A second subset of fill shapes is then created based on the extracted capacitance values, and if the estimated capacitance contribution is significant, the capacitance extracted using the selected capacitance model. Additional iterations are performed for additional signal shapes. A computer program product embodied in a non-transitory computer readable medium for design analysis is disclosed comprising: code for obtaining a semiconductor design layout wherein the design layout includes fill shapes; code for identifying signal lines within the semiconductor design layout; code for calculating signal capacitance values for capacitance on the signal lines; code for identifying a subset of shapes from the fill shapes; code for estimating capacitance values between signal shapes and shapes from the subset of shapes; code for iterating to a second subset of shapes from the fill shapes based on the estimating; and code for calculating capacitance between signal shapes and the second subset of shapes. In embodiments, the computer program product includes code for continuing the iterating to further subsets of fill shapes based on the estimating. In some embodiments, a computer-implemented method for design analysis performs capacitance calculations.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for capacitance calculation.

FIG. 2 is flow diagram capacitance calculation iteration.

FIG. 3 shows an example layout with fill.

FIG. 4A is an example layout illustrating track fill.

FIG. 4B is an example layout illustrating pattern fill.

FIG. 5 is a diagram of system that performs capacitance calculation.

### DETAILED DESCRIPTION

### Configuration Overview

In many semiconductor designs the various layers in the layout are not uniformly utilized. Some areas of a given layout have very heavy utilization with many shapes while other areas are sparsely used with very few shapes. This unevenness can cause problems in fabrication, especially in semiconductor processes with many layers and very fine geometry. To help make the utilization of the different areas on a layer more uniform, shapes are added during the IC design process. These shapes are often referred to as fill shapes. Fill shapes are commonly added in the metal layers in an attempt to address inherent variances in the comparative thickness of layers with different levels of utilization. The fill shapes are needed to minimize manufacturing variations due to chemical mechanical polishing (CMP) and help improve reliability and yield. However, as the number of metal layers increases and wire dimensions decrease in more advanced semiconductor technology, the parasitic capacitance associated with fill metal has become more significant. That is, if not properly accounted for, fill shapes can potentially lead to timing violations, signal integrity issues, and greater power consumption.

Fill shapes can either be connected to nearby ground rails or left unconnected (floating). Floating fill shapes are predominantly used in current digital integrated circuit (IC) designs. When compared with grounded fill shapes, floating shapes generally contributes less incremental total net capacitance and do not require the placement of vias to the power grid. However, floating fill shapes typically increase the coupling capacitance between nearby nets. Accounting for the complex capacitive interactions often caused by floating fill shapes typically requires sophisticated modeling techniques that can have a significant impact on runtime of the analysis tools.

While irregular geometric fill patterns contribute to the intrinsic complexity of modeling floating fill shape capacitance, these shapes improve planarization in designs implemented in 45 nm and smaller technologies. Compared with traditional track fill, these irregular fill patterns lead to complex intra-layer and inter-layer signal to fill, as well as fill to fill capacitive interactions which are more difficult to accurately model. Irregular fill shapes can include shapes which fall outside normal wiring tracks or which do not have a uniform shape. Furthermore, the number of individual fill polygons in a geometric fill scheme can be substantially larger compared to comparable track-fill implementations, which can lead to significantly longer runtimes for capacitance extraction. Techniques are described herein that allow complex irregular fill shapes, as well as regular fill shapes, to be efficiently and accurately modelled.

The method for capacitance extraction for designs with floating fill shapes can be iterative, with a subset of fill shapes analyzed in each iteration. Fast estimates for capacitive contributions of un-extracted fill shapes to signals are created. The estimates are then used to determine the fill shape capacitance extraction algorithm to use. Specific individual fill shapes or collections of fill shapes to extract are selected, and then a capacitance model is selected from a set of capacitance calculation models of varying speed and accuracy. The estimates for the fill shape contribution to signal capacitance are then updated based on the extracted capacitance of the selected fill shapes.

An example pseudo code description of an embodiment of the method of calculating capacitance contributions of fill shapes for signals is shown here:
1. Extract signal net ‘A’ and other non-fill metal shapes.
2. Estimate capacitance contribution to signal capacitance for un-extracted fill shapes (Cest).
3. Select fill shapes with largest Cest values to extract.
4. Select a capacitance model based on the ratio of Cest to the estimated overall signal ‘A’ capacitance.
5. Update Cest for un-extracted fill shapes based on computed fill shape capacitances.
6. Go to #3 if fill shapes with significant Cest values are un-extracted.

In step four, any one of a variety of capacitance models can be selected, including one or more of a formula based model, a pattern matching model, a pattern matching model with interpolation, and a field-solver model. The models can be represented as a function Mₓ(Eₓ, Tₓ) where x is the model identifier, Eₓ is the error estimation for the model x, and Tx is the computational requirements (e.g. compute time) for model x. The models may be identified in such a way that, in general, each successive model has a lower error estimate but higher computations requirements, although other embodiments may not have this strict ordering. If the models are arranged in this fashion, for M₁ through Mₙ, E₁<E₂< . . . <E_{N}, and T₁>T₂> . . . >T_{N}.

Another embodiment of the capacitance extraction methodology for designs with floating metal fill shapes includes extracting one or more signal nets to calculate the signal-to-signal (Css) and signal-to-ground capacitance (Csg) and selecting a subset of fill shapes. The selection of the subset can be done by numerous methods, including a simple distance calculation analyzing the distance between a signal and the fill shapes. Estimates for signal-to-fill-shape capacitance (Csf) are created for the subset of fill shapes using a simple model and then, based on the estimated Csf and/or Css+Csg, estimates for the capacitance contributions of the un-extracted fills to the signal net capacitances (total capacitance and/or coupling capacitance) are determined (Cest).

A fill extraction algorithm is dynamically determined based on the estimates for capacitance contributions. The fill extraction algorithm is selected based on choosing an algorithm that can deliver a result with an acceptable expected error at the lowest computational cost. The capacitance extraction algorithm is selected from a set of models with varying speed and accuracy characteristics based on Cest. Once the extraction algorithm has been selected, the individual fill shapes and/or collections of fill shapes with significant Cest values are selected for extraction. Capacitance from signal to fill shapes (Csf), capacitance between fill shapes (Cff), and capacitance from a fill shape to a ground (Cfg) are extracted. Additional estimates for Csf and Cff to un-extracted fills can also be computed. Cest can then be updated based on the computed capacitance values for the un-extracted fills and the steps outlined in this paragraph repeated to select additional un-extracted fills with a significant Cest for extraction. Additionally, the entire method can be iterated to add additional signal nets for extraction. The algorithm is finished once Cest for the remaining un-extracted fill shapes is sufficiently small for the selected signals.

Note that the algorithm described above is a generic description of the proposed methodology. Specific embodiments of the methodology can have varying degrees of complexity for the computation of Cest, the selection criteria for the fills to extract, the set of capacitance models used, and the signal net extraction order. The methodology is an iterative process where a subset of the fill shapes in the design are extracted during each iteration. The methodology leverages fast estimates of the signal capacitance contributions of individual or collections of un-extracted fill shapes to determine the fill extraction algorithm. The fill extraction algorithm used during each iteration is chosen from a selection of capacitance models with different speed and accuracy characteristics. The methodology provides significantly faster runtime with similar accuracy to previous methods. The methodology described herein provides a significant speedup of calculation over previously known methodologies while maintaining a high level of accuracy for the extracted capacitance versus a reference field solver.

### Further Details

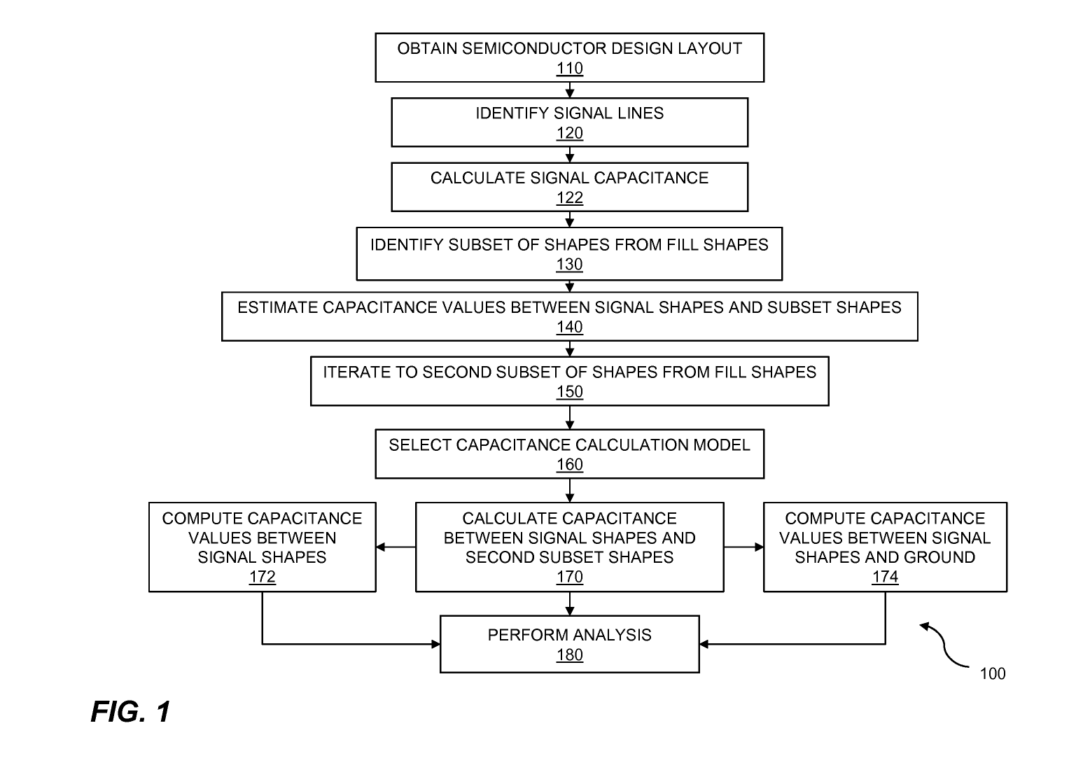

FIG. 1 is a flow diagram 100 for capacitance calculation. The flow 100 describes one embodiment of a computer-implemented method for design analysis, though the method can include further steps. The flow 100 includes obtaining a semiconductor design layout 110, wherein the design layout includes fill shapes. The design layout can be obtained by various methods, including, but not limited to, reading one or more files from a computer readable media, receiving information over a computer network, receiving information from another electronic computer-aided design (ECAD) tool, processing a design description to generate the design layout, or any other method of obtaining the design layout. The flow 100 can further comprise determining the fill shapes to be included in the design layout. The fill shapes may be added to a design layout that does not include any fill shapes, or additional fill shapes may be added to a design layout that already includes some fill shapes. The fill shapes can be designed to increase planarity of a resulting fabricated semiconductor. In some embodiments, the fill shapes are added to underutilized areas on a layer. The fill shapes can be added to more than one layer in some embodiments. The added fill shapes can be regular fill shapes and/or irregular fill shapes, depending on the embodiment and the design layout. In some embodiments, the added regular fill shapes can be track fill shapes that have a standard line width and spacing with signal lines.

The flow 100 includes identifying signal lines 120 within the semiconductor design layout. In some embodiments, the signal lines are handled one signal line at a time, with the capacitance contribution from fill shapes extracted for one signal before working on another signal line. In other embodiments, multiple signal lines are handled in each pass through the methodology, including at least one embodiment where all signal lines are handled concurrently. The flow 100 includes calculating signal capacitance values 122 for capacitance on the signal lines. Any type of capacitance model can be used to calculate the signal capacitance values, but in at least one embodiment, a high accuracy capacitance model is used to calculate the signal capacitance values. The signal capacitance values can include both signal to ground capacitance and signal to signal capacitance.

The flow 100 includes identifying a subset of shapes from the fill shapes 130. The subset of fill shapes can be determined by numerous methods. In one embodiment, the subset of fill shapes is identified by finding the fill shapes that are adjacent to the signal shapes. In another embodiment, the subset of fill shapes is identified by determining those fill shapes within a predetermined distance from signal shapes. In another embodiment, the subset of fill shapes is identified, at least in part, by finding fill shapes that are adjacent to the fill shapes that are, in turn, adjacent to the signal shapes. In another embodiment, a combination of distance from the signal lines and some physical dimension of the fill shapes is used to identify the subset of shapes.

The flow 100 includes estimating capacitance values between signal shapes and shapes from the subset of shapes 140. A simple capacitance model can be used to estimate the capacitance values between the signal shapes and the fill shapes already identified as part of the subset of shapes. The simple capacitance model can be chosen to allow the estimation to be made with a minimal amount of computing resources. In at least one embodiment, the simple capacitance model is a formula based on parameters of the design layout. One simple formula that can be used in some embodiments is found by multiplying the permittivity of the material between conductors by the overlap area of metal faces of conductors, and then dividing by the distance between the metal faces of the conductors. In another embodiment, the simple model uses information about the topology of the conductors to find a capacitance in a table. Other models can be used in other embodiments.

The flow 100 includes iterating to a second subset of shapes from the fill shapes 150 based on the estimating. The estimations can be used to find additional fill shapes to add to the second subset of shapes, and/or the estimations can be used to remove some fill shapes from the second subset of shapes. In at least one embodiment, the estimations are used to determine a percentage contribution of a particular fill shape to the capacitance of a signal. Those fill shapes with the greatest contribution to the capacitance of a signal can be left in the second subset of fill shapes. If no additional capacitance contributions from other fill shapes can be found, the iterating may be terminated, so the iterating can be terminated based on the further capacitance values.

The flow 100 can further include selecting, from a plurality of capacitance calculation models, a capacitance model 160 based on the estimating. In at least one embodiment, the plurality of capacitance models include one or more of a formula based on physical characteristics from the design layout, a table lookup, a pattern matching lookup, a pattern matching lookup with interpolation, and a field solver. The plurality of capacitance models can have differing accuracy and differing computational requirements. In at least one embodiment, the capacitance model is selected from the plurality of capacitance models by determining an acceptable error for the extraction of the estimated capacitance, and then choosing the capacitance model that uses the least amount of computational resource while still meeting the acceptable error level.

Once the capacitance model has been selected, the flow 100 includes calculating capacitance between signal shapes and the second subset of shapes 170 using the selected capacitance model. So, the calculating can include dynamically determining capacitance models and can further comprise calculating the capacitance values based on the selecting. The flow 100 in some embodiments can further include computing capacitance values between the signal shapes 172 and/or computing capacitance values between the signal shapes and ground 174, although in some embodiments, the previously calculated capacitance values of the signal to signal capacitance and the signal to ground capacitance are used. The calculated capacitance contribution for the second subset of shapes can be added to the capacitance of the signals and the fill shapes that had their capacitance calculated removed from the subset of fill shapes as being previously extracted fill shapes. The flow 100 can further include estimating further capacitance values for a set of fill shapes that are not included in the second subset. The calculated values can be used to update the estimated capacitance values. Additional iterations can be performed to find and calculate capacitance contributions from fill shapes with a significant contribution to the capacitance for a signal.

The flow 100 can further include performing analysis 180, including, but not limited to, performing timing analysis, signal integrity analysis, or circuit simulation using the capacitance calculated between signal shapes and the second subset of shapes. Any type of analysis can be performed using the calculated, or extracted, capacitance values for the signals based on the fill shapes that contribute a significant amount of capacitance to the signals. If signals remain for analysis, the flow 100 can further include identifying additional signal shapes from the design layout for capacitance calculation to the fill shapes. Once the additional signal shapes are identified, the flow 100 can be performed using the additional signal shapes. Various steps in the flow 100 may be changed in order, repeated, omitted, or the like without departing from the disclosed concepts. Various embodiments of the flow 100 may be included in a computer program product embodied in a non-transitory computer readable medium that includes code executable by one or more processors.

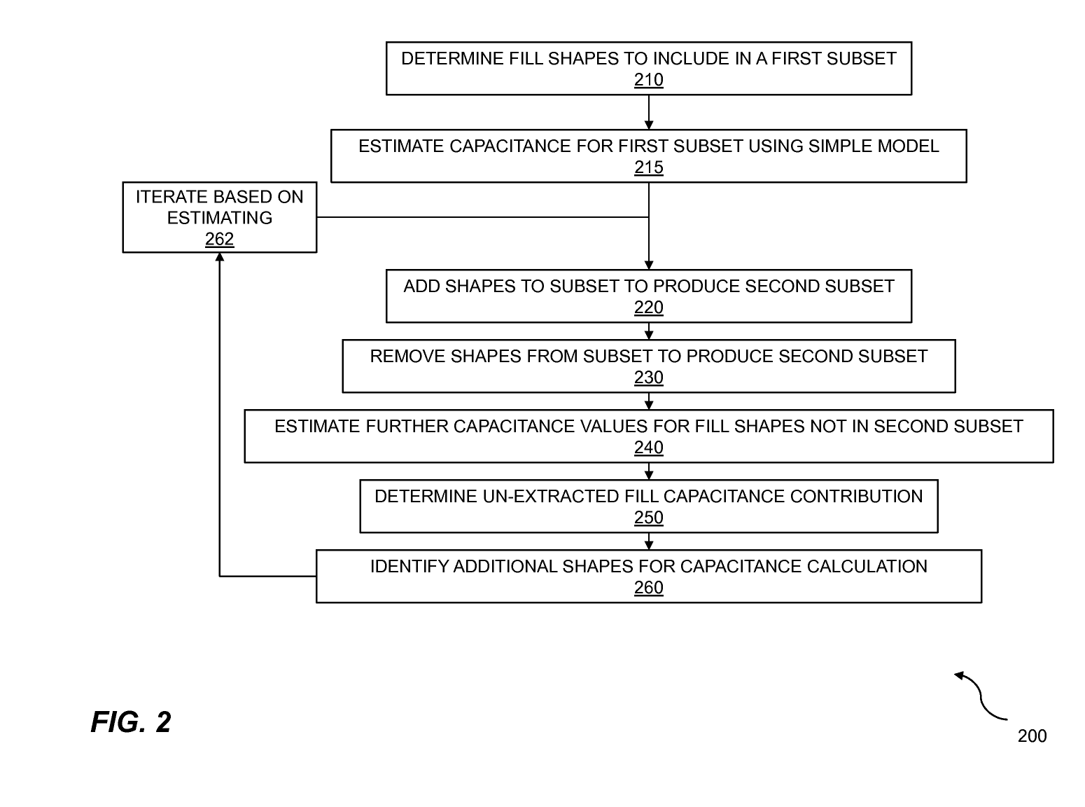

FIG. 2 is flow diagram 200 showing calculation iteration. The flow 200 includes determining fill shapes to include in a first subset of fill shapes 210 from the design layout. The first subset can be chosen by any method, including a proximity of the fill shapes to one or more signals. The flow 200 continues with estimating capacitance for the first subset of fill shapes using a simple model 215. The simple model can be a linear formula or some other method of estimating capacitance with minimal computational resource usage. The flow 200 can further include adding shapes to the subset of shapes to produce the second subset of shapes 220. The added shapes can be selected based on the estimating. The adding can result in including capacitance values above a certain threshold in some embodiments. The flow 200 can further include removing shapes from the subset of shapes to produce the second subset of shapes 230. The removed shapes can be selected based on the estimating. The removing is based on the estimating producing capacitance values below a certain threshold in some embodiments.

The flow 200 can continue with estimating further capacitance values for fill shapes not in the second subset 240. In some embodiments, the fill shapes not already in the second subset are selected based on the estimated capacitance values of fill shapes included in the second subset. Capacitance values for the fill shapes in the second subset are calculated with a dynamically chosen capacitance model in some embodiments. The capacitance model can be chosen to minimize computational drain while maintaining a desired error level for the calculated capacitance. After a fill shape has had its capacitance calculated using the dynamically chosen capacitance model, it can be deemed to have had its capacitance extracted. The calculating can include determining capacitance values from one fill shape to another fill shape within the subset of shapes. The calculating can include determining capacitance values from one fill shape within the subset of shapes to a signal shape within the signal shapes. The extracted capacitance can be added to capacitance for signals as determined by the circuit topology.

The flow 200 can further include determining un-extracted fill capacitance contributions 250 to signal-net capacitances based on the capacitance values which were calculated and estimated. The determined un-extracted fill capacitance contributions can be used to identify additional shapes for capacitance calculation 260 in some embodiments. These additional shapes could be signal shapes or fill shapes. The flow 200 can further include continuing the iterating to further subsets of fill shapes based on the estimating 262. Iterating may continue until no more fill shapes are known to significantly contribute to a signal of interest. Various steps in the flow 200 may be changed in order, repeated, omitted, or the like without departing from the disclosed concepts. Various embodiments of the flow 200 may be included in a computer program product embodied in a non-transitory computer readable medium that includes code executable by one or more processors.

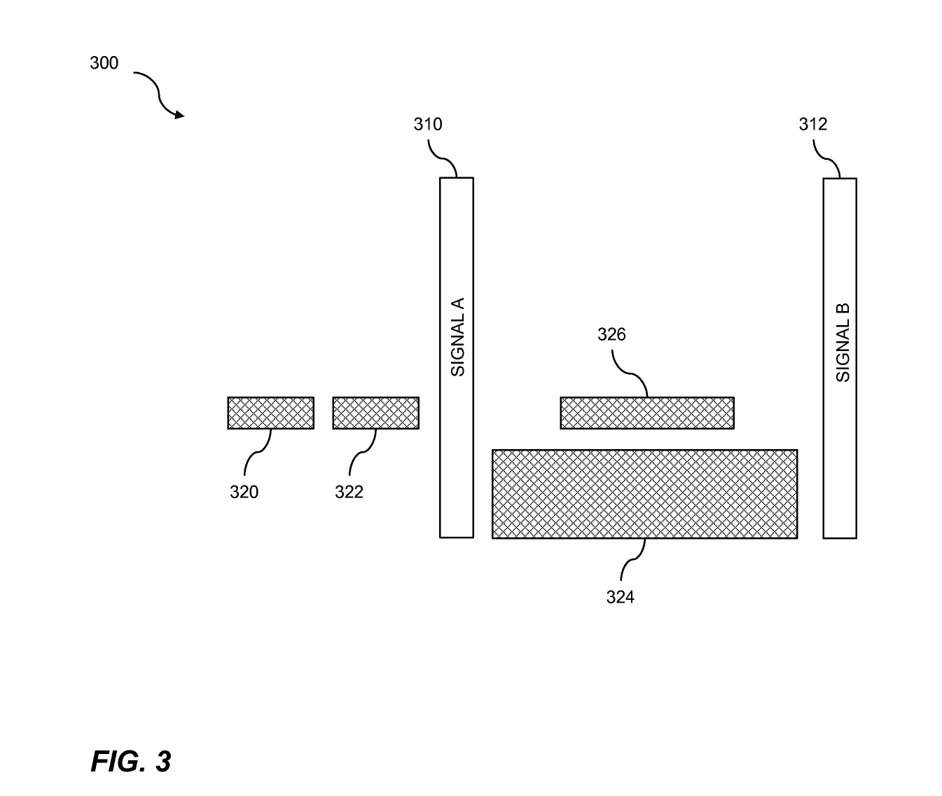

FIG. 3 shows an example layout 300 with fill. The layout 300 includes a first signal shape 310, SIGNAL A and a second signal shape 312, SIGNAL B. The example layout 300 also includes fill shapes, including a first fill shape 320, a second fill shape 322, a third fill shape 324 and a fourth fill shape 326. One or more of the a first fill shape 320, a second fill shape 322, a third fill shape 324 and a fourth fill shape 326 can be made of metal, thus, the fill shapes can include metal shapes. In some embodiments, one or more of the metal shapes are electrically floating, not grounded. In some cases that fill shapes are regular, or placed at a standard width and spacing with other shapes of the layout, but in other cases, the fill shapes can be irregular, such as the third fill shape 324, which is much wider than the other shapes of the layout 300.

FIG. 3 can be used for an example of calculating capacitance. In following calculations, Cxy/CExy are used to represent a calculated (Cxy) or estimated (CExy) capacitance between two shapes where x and y indicate the shapes. The letter ‘a’ is used to indicate the first signal shape 310, ‘b’ is used to indicate the second signal shape 312, ‘g’ is used to indicate ground, ‘1’ is used to indicate the first fill shape 320, ‘2’ is used to indicate the second fill shape 322, ‘3’ is used to indicate the third fill shape 324, and ‘4’ is used to indicate the fourth fill shape 326. CTEAx is used to represent an absolute estimated capacitance contribution at the shape identified by ‘x’. % CTExy is used to represent the ratio of CTExy to the total capacitance of x and % CTEFx is used to represent the ratio of the summation of the capacitance of all fill shapes to the total capacitance of x.

Capacitance can be calculated using a process beginning with computing capacitance between the signals and from the signals to ground. First, Cab, Cag, and Cab are calculated. The calculation can be performed using any appropriate method of calculating capacitance based on layout information of an integrated circuit, several of which are known to those of ordinary skill in the art. Next, various techniques can be used to choose the subset of the fill shapes to use for estimating capacitance, including a distance from the signal shapes. In the example, the first fill shape 320 is not included in the subset for signal A, but the second fill shape 322, the third fill shape 324, and the fourth fill shape 326 are included in the subset of fill shapes for A. The first fill shape 320 and the second fill shape 322 are not included in the subset of fill shapes for signal B. Then capacitance between the subset of the fill shapes and the signals and ground are estimated using a simple model. The model can be chosen to minimize computational requirements and/or memory footprint with little importance placed on potential model errors. Examples of simple models include formulas and lightweight table-based techniques. In at least one embodiment, the simple model is a non-iterative, linear calculation based on physical characteristics of the layout. One example formula that can be used is CExy=(ε×Axy)/Dxy, where ε is the permittivity of the material between conductors x and y, Axy is the overlap area of metal faces of conductors x and y, and Dxy is the distance between metal faces of conductors x and y. So in the example of FIG. 3, CEa2, CE2g, CEa3, CEb3, CE3g, CEa4, CEb4, CE4g can all be estimated using a simple model.

Once the capacitances have been estimated, the estimated capacitance contribution of fill metal to signal conductors is determined using circuit analysis of the various capacitances. So:

CTEa2=(CEa2×CE2g)/(CEa2+CE2g),

CTEa3=(CEa3×CE3g+CEa3×CE3b)/(CEa3+CEb3+CE3g),

CTEa4=(CEa4×CE4g+CEa4×CE4b)/(CEa4+CEb4+CE4g),

CTEb3=(CEb3×CE3g+CEb3×CE3a)/(CEa3+CEb3+CE3g), and

CTEb4=(CEb4×CE4g+CEb4×CE4a)/(CEa4+CEb4+CE4g).

A percentage of the estimated capacitance contribution with respect to total capacitance for a signal is used to help determine which of the fill shapes significantly contribute to the capacitance of a signal. So:

% CTEa2=CTEa2/(CTEa2+CTEa3+CTEa4+Cag+Cab),

% CTEa3=CTEa3/(CTEa2+CTEa3+CTEa4+Cag+Cab),

% CTEa4=CTEa4/(CTEa2+CTEa3+CTEa4+Cag+Cab),

% CTEb3=CTEb3/(CTEb3+CTEb4+Cbg+Cab), and

% CTEb4=CTEb4/(CTEb3+CTEb4+Cbg+Cab).

The percentage contribution for the fill shapes are used to select fill shapes that contribute significantly to the capacitance of a signal. In at least one embodiment, a fill shape ‘f’ is selected for capacitance extraction for a signal ‘s’ if its percentage contribution % CTEsf is greater than a predetermined constant value. In other embodiments, a fill shape is selected for capacitance extraction if its percentage contribution is one of the top contributors among fill shapes for a signal, such as the top ‘N’ or top ‘N %’ of the fill shapes. In this example, the third fill shape 324 is the only fill shape selected for extraction for both signal A 310 and signal B 312.

The selected fill shapes can then have their capacitance extracted, or calculated, using a more accurate method than was used for the estimation. Various methods can be used to select the model used for the extraction. In some embodiments, at least three models are available for selection: a formula based model, a pattern matching model, and a field solver model. In at least one embodiment, a model is selected based on the model with the lowest computational requirements that also meets an error target. The selected model is then used to extract the capacitance for the selected fill shapes, CEa3, CEb3, and CEbg, in the example. The extracted values can then be added to the capacitance of the signals, CEab, CEag and CEbg. Because the capacitance contribution of the fourth fill shape 326 is at least partially dependent upon the capacitance of the third fill shape 324, those capacitance estimations can be updated using the extracted capacitances for the third fill shape 324. Additionally, the estimated capacitance contributions and percentage contributions of the un-extracted fill shapes can be updated as CTEa4=(CEa4×(CE4g+CE4b+F(CE34))/(CEa4+CEb4+CE4g+F(CE34)), where F(CE34) is a function that determines the contribution of the estimated coupling between the third fill shape 324 and the fourth fill shape 326 to the total capacitance of signal A 310. This function can be highly accurate, such as a matrix formulation, or approximate, depending on the computational requirements and accuracy desired. A similar calculation is made for signal B 312.

The percentage estimated capacitance contribution, with respect to total capacitance, is then updated as shown (Note that Cag and Cab now contain capacitance contributions from the third fill shape 324):

% CTEa2=CTEa2/(CTEa2+CTEa4+Cag+Cab)

% CTEa4=CTEa4/(CTEa2+CTEa4+Cag+Cab)

% CTEb4=CTEb4/(CTEb2+CTEb4+Cbg+Cab)

In the example, the new % CTEa4 is large enough to make a significant contribution to the total capacitance of signal A 310. So the iteration continues by selecting a method to use for extraction, and then extracting the capacitance for the fourth fill shape 326 using the selected method and adding the extracted capacitance to the capacitance for signal A 310. Additional iterations can be performed in some embodiments, adding fill shapes to, or deleting fill shapes from, the subset of fill shapes during each pass. But in this example, it is determined that no further fill shapes need evaluation, so the calculations are complete.

Note that in this example, only two fill shapes (third fill shape 324 and fourth fill shape 326) were explicitly extracted. In at least some prior methods where the fills are extracted based on a predetermined number of passes, the second fill shape 322, the third fill shape 324, and the fourth fill shape 326 would be extracted during the first pass through the algorithm, and all fill shapes would be extracted during the second pass through the algorithm. It should also be noted that the formulas used in this example are only one embodiment, and that other embodiments may utilize different formulas for at least computing estimated capacitance (CExy), estimated total capacitance (CTExy), and percentage capacitance contribution (% CTExy). Various embodiments will also use different methods to determine if a fill shape has a significant CTExy value for selection for extraction. This example uses a constant threshold of % CTExy, but a more complex formulation which also takes into account the absolute value of the capacitances can also be used. Various embodiments can also use various methods to select a capacitance calculation method from set of possible models.

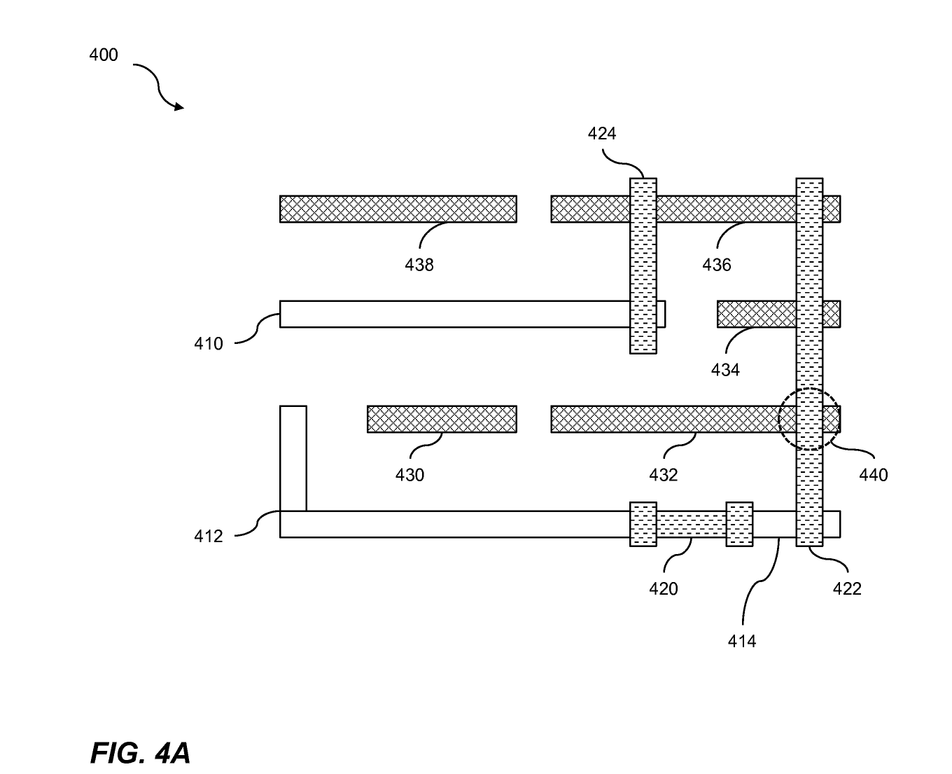

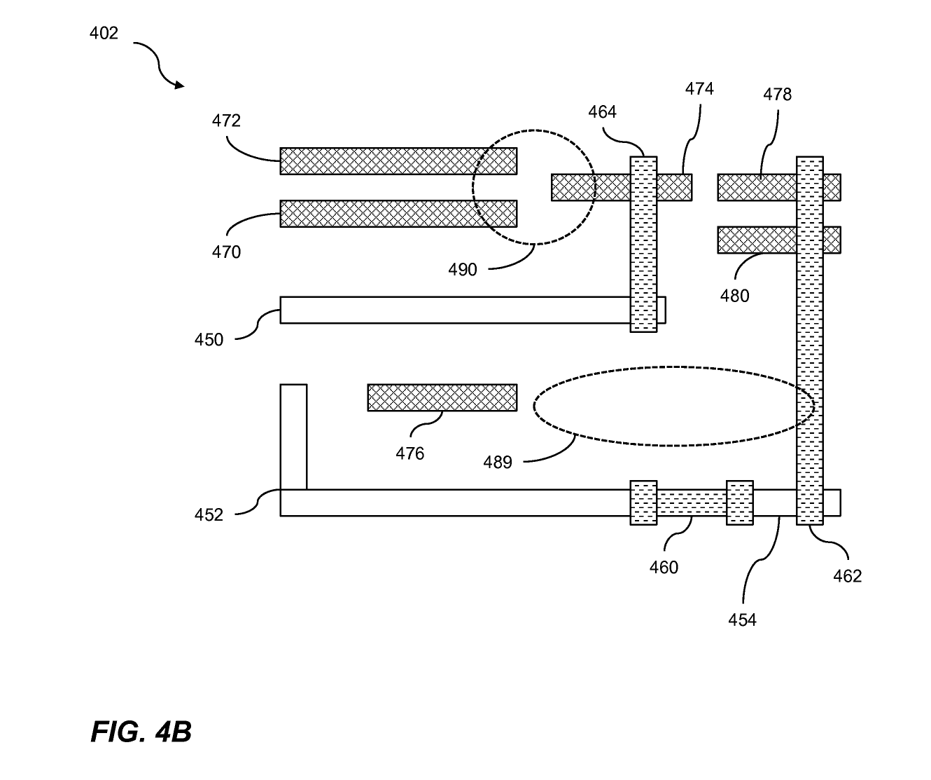

FIG. 4A shows an example layout 400 with track fill. The layout 400 includes two layers. Shapes in the first layer are shown as solid white or as a cross-hatched region. The shapes of the second layer are shown with a dashed-hatch pattern. The first layer includes a first signal shape 410 and a second signal shape 412. The first layer also includes a third signal shape 414 that is connected to the second signal shape 412 by the signal shape 420 of the second layer. The first layer also includes fill shapes, including a first fill shape 430, a second fill shape 432, a third fill shape 434, a fourth fill shape 436, and a fifth fill shape 438. Note that the fill shapes 430-438 of the first layer all have the same width and are positioned on routing tracks with regular spacing between them. This can be referred to as a track fill pattern.

The second layer includes the connecting signal shape 420 which connects the second signal shape 412 and the third signal shape 414 of the first layer. The second layer also includes a fourth signal shape 422 and a fifth signal shape 424. In some embodiments, the second layer also includes fill shapes, but fill shapes are omitted in this example to help make the layout 400 clearer.

To calculate capacitance for the signal shapes of the layout 400, signal capacitance for the signal shapes to ground and to each other can first be calculated. Next, in some embodiments, a signal shape is selected, such as the third signal shape 414. Then a first subset of the fill shapes that are within one track of the selected signal shape can be selected, such as the second fill shape 432. An estimate is then made of the capacitance contribution of the second fill shape 432 to the capacitance of the third signal shape 414. If it is deemed to be significant, the capacitance contribution of the second fill shape to the selected signal shape 414, and in some embodiments other signal shapes such as the signal shape 422 which overlaps with the second fill shape 432 at position 440, are calculated with a dynamically selected capacitance model. The capacitance model can be selected to use a minimal amount of computation to calculate the capacitance within an allowable error range.

Once the capacitance contributions of the second fill shape 432 have been calculated or extracted, additional fill shapes may be selected to form a second subset of fill shapes. Because the signal shape 414 is connected to the connecting signal shape 420 and the signal shape 412, the first fill shape 430 is added to the second subset. And because of a significant contribution of the signal to signal capacitance between the third signal shape 414 and the fourth signal shape 422 due to their overlap, fill shapes that overlap the fourth signal shape 422, such as the third fill shape 434 and the fourth fill shape 436 are also added to the second subset. The capacitance contributions of the fill shapes in the second subset are then estimated and some of the fill shapes can be dropped from the second subset, such as the third fill shape 434, if they are found contributing too little capacitance to warrant calculation.

So then the capacitance contributions of the remaining fill shapes of the second subset are calculated using a dynamically selected capacitance model and the capacitance contributions added to the signal capacitances. Once no more un-extracted fill shapes are deemed to be contributing significant capacitance to a signal of interest, the methodology is complete.

FIG. 4B shows an example layout 402 with pattern fill. The layout 402 includes two layers. Shapes in the first layer are shown as solid white or as a cross-hatched region. The shapes of the second layer are shown with a dashed-hatch pattern. The first and second layers include similar signal shapes to the layout 400 of FIG. 4A, with a first signal shape 450, a second signal shape 452, and a third signal shape 454 on the first layer and a connecting signal shape 460, a fourth signal shape 462, and a fifth signal shape 464 on the second layer. Non-regular fill shapes are also included on the first layer, including a first fill shape 470, a second fill shape 472, a third fill shape 474, a fourth fill shape 476, a fifth fill shape 478, and a sixth fill shape 480. Note that the fill shapes 470-480 are not all positioned on a standard routing track as they were in FIG. 4A. This can be referred to as a pattern fill. This can lead to some shapes that only partially overlap, such as at position 490. In some embodiments, the fill shapes have different irregular widths or shapes. In some embodiments of pattern fill, some areas do not include fill shapes, such as the area 489. In some embodiments, fill shapes are added into an area such as the area 489 to improve manufacturing yields of the IC.

The techniques described herein can also be used for design layouts using pattern fill, including those with irregular fill shapes. The methodology can progress as described above, but in some cases, the dynamically selected capacitance model can require more computational resources due to the irregular fill shapes. As an example, a first signal shape 450 can be selected along with a signal shape 464 as having a significant capacitance contribution to the first signal shape 450. The capacitance values for those signals is then calculated, including the capacitance from each signal shape to ground and the capacitance between the two signal shapes. Then a first subset of fill shapes is selected, such as the first fill shape 470, the third fill shape 474 and the fourth fill shape 476. The capacitance contributions of those fill shapes is then estimated using a simple formula, and based on the estimating, the second fill shape 472 is added to create a second subset.

A capacitance model is chosen based on the estimating. Because the first and second fill shapes 470 and 472 are misaligned with the third fill shape 474, the model can require greater computational resources to calculate the capacitance contribution between the shapes at a desired accuracy. Once the capacitance model has been selected, the capacitance contribution for the second subset is calculated using the model and the calculated capacitance contribution is added to the capacitance of the signals. Additional iterations to look at additional fill shapes and/or additional signal shapes can be performed until there are no fill shapes with significant capacitance contribution to a signal shape of interest that have not been extracted.

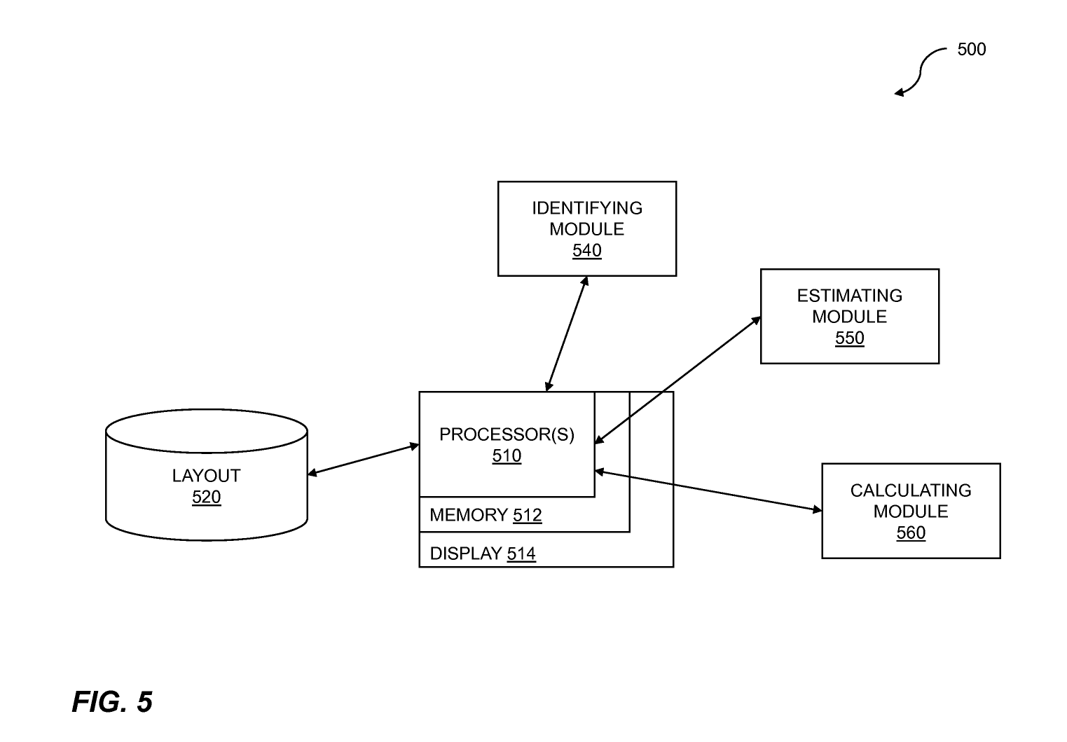

FIG. 5 is a system diagram for capacitance calculation. The example system 500 includes one or more processors 510 coupled to memory 512 which can be used to store computer code instructions and/or data, design descriptions, design layouts, computer code of electronic design automation programs, intermediate data, and the like. A display 514 is also included in some embodiments, and can be any electronic display, including but not limited to, a computer display, a laptop screen, a net-book screen, a tablet screen, a cell phone display, a mobile device display, a remote with a display, a television, a projector, or the like. The layout 520, is stored on a computer readable media, such as a hard drive, which is coupled to the one or more processors 510. A computer program product running on the one or more processors 510 is able to perform capacitance calculation in some embodiments.

An identifying module 540 is included in the system 500 to identify signal lines within the semiconductor design layout. An estimating module 550 is included in the system 500 to estimate capacitance values between signal shapes and shapes from the subset of shapes. A calculating module 560 is also included in the system 500 to calculate signal capacitance values for capacitance on the signal lines. In at least one embodiment, the functions of the identifying module 540, the estimating module 550, and the calculating module 560, are accomplished or augmented by the one or more processors 510.

The system 500 can include a computer program product embodied in a non-transitory computer readable medium for capacitance calculation comprising: code for implementing calculating logic for determining a number of times that a portion of a memory has been accessed; code for obtaining a semiconductor design layout wherein the design layout includes fill shapes; code for identifying signal lines within the semiconductor design layout; code for calculating signal capacitance values for capacitance on the signal lines; code for identifying a subset of shapes from the fill shapes; code for estimating capacitance values between signal shapes and shapes from the subset of shapes; code for iterating to a second subset of shapes from the fill shapes based on the estimating; and code for calculating capacitance between signal shapes and the second subset of shapes.

Each of the above methods may be executed on one or more processors on one or more computer systems. Embodiments may include various forms of distributed computing, client/server computing, and cloud based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general purpose hardware and computer instructions, and so on.

A programmable apparatus which executes any of the above mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are neither limited to conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the forgoing examples should not limit the spirit and scope of the present invention; rather it should be understood in the broadest sense allowable by law.

What is claimed is:

1. A computer program product embodied in a non-transitory computer readable medium for design analysis comprising:
code for obtaining a semiconductor design layout wherein the design layout includes fill shapes;
code for identifying signal lines within the semiconductor design layout;
code for calculating signal capacitance values for capacitance on the signal lines;
code for identifying a subset of shapes from the fill shapes;
code for estimating capacitance values between signal shapes and shapes from the subset of shapes;
code for iterating to a second subset of shapes from the fill shapes based on the estimating; and
code for calculating capacitance between signal shapes and the second subset of shapes.

2. The computer program product of claim 1 further comprising code for continuing the iterating to further subsets of fill shapes based on the estimating.

3. The computer program product of claim 1 further comprising code for computing capacitance values between the signal shapes.

4. The computer program product of claim 1 further comprising code for computing capacitance values between the signal shapes and ground.

5. The computer program product of claim 1 further comprising code for estimating further capacitance values for a set of fill shapes that are not included in the second subset.

6. The computer program product of claim 5 wherein the iterating is terminated based on the further capacitance values.

7. The computer program product of claim 1 further comprising code for removing shapes from the subset of shapes to produce the second subset of shapes.

8. The computer program product of claim 7 wherein the removing is based on the estimating producing capacitance values below a certain threshold.

9. The computer program product of claim 1 further comprising code for adding shapes to the subset of shapes to produce the second subset of shapes.

10. The computer program product of claim 9 wherein the adding results in including capacitance values above a certain threshold.

11. The computer program product of claim 1 wherein the calculating includes dynamically determining capacitance models.

12. The computer program product of claim 1 further comprising code for determining the fill shapes to be included in the design layout.

13. The computer program product of claim 12 wherein the fill shapes are designed to increase planarity of a resulting fabricated semiconductor.

14. The computer program product of claim 1 further comprising code for performing timing analysis, signal integrity analysis, or circuit simulation analysis using the capacitance calculated between signal shapes and the second subset of shapes.

15. The computer program product of claim 1 wherein the fill shapes include metal shapes.

16. The computer program product of claim 15 wherein the metal shapes are electrically floating.

17. The computer program product of claim 1 wherein the fill shapes are irregular.

18. The computer program product of claim 1 wherein the calculating includes determining capacitance values from one fill shape to another fill shape within the subset of shapes.

19. The computer program product of claim 1 wherein the calculating includes determining capacitance values from one fill shape within the subset of shapes to a signal shape within the signal shapes.

20. The computer program product of claim 1 further comprising code for identifying additional signal shapes from the design layout for capacitance calculation to the fill shapes.

21. The computer program product of claim 1 further comprising code for determining un-extracted fill capacitance contributions to signal-net capacitances based on the capacitance values which were calculated and estimated.

22. The computer program product of claim 1 further comprising code for selecting from a plurality of capacitance calculation models a capacitance model based on the estimating.

23. The computer program product of claim 22 further comprising code for calculating the capacitance values based on the selecting.

24. A computer system for design analysis comprising:
a memory which stores instructions;
one or more processors coupled to the memory wherein the one or more processors are configured to:
obtain a semiconductor design layout wherein the design layout includes fill shapes;
identify signal lines within the semiconductor design layout;
calculate signal capacitance values for capacitance on the signal lines;
identify a subset of shapes from the fill shapes;
estimate capacitance values between signal shapes and shapes from the subset of shapes;
iterate to a second subset of shapes from the fill shapes based on the estimating; and
calculate capacitance between signal shapes and the second subset of shapes.

25. A computer-implemented method for design analysis comprising:
obtaining a semiconductor design layout wherein the design layout includes fill shapes;
identifying signal lines within the semiconductor design layout;
calculating signal capacitance values for capacitance on the signal lines;
identifying a subset of shapes from the fill shapes;
estimating capacitance values between signal shapes and shapes from the subset of shapes;
iterating to a second subset of shapes from the fill shapes based on the estimating; and
calculating capacitance between signal shapes and the second subset of shapes.
